(19) United States
(12) Patent Application Publication
(10) Pub. No.: US 2007/0256974 A1
(43) Pub. Date: Nov. 8, 2007

(54) IMMERSED MEMBRANE FILTRATION CYCLE WITH EXTENDED OR TMP CONTROLLED CYCLE TIME

(76) Inventors: Fraser Charles Kent, Guelph (CA); Nicholas William H. Adams, Hamilton (CA); Jason Cadera, Guelph (CA)

Correspondence Address: GENERAL ELECTRIC CO.;GLOBAL PATENT OPERATION, 187 Danbury Road, Suite 204, Wilton, CT, 06897-4122, US

(21) Appl. No.: 11/745,762

(22) Filed: May 8, 2007

Related U.S. Application Data
(60) Provisional application No. 60/798,293, filed on May 8, 2006.

(51) Int. Cl. B01D 65/02

(52) U.S. Cl. 210/636; 210/321.69; 210/650

(57) ABSTRACT

A filtration process has permeation periods and deconcentration periods. The length of the permeation period or periods between backwashes is chosen, or controlled, to allow the system to reach a TMP and flux value at which the system is operating near its mechanical limits.

### PRIORITY OF INVENTION

This non-provisional application claims the benefit of priority under 35 U.S.C. §119(e) to U.S. Provisional Patent Application Ser. No. 60/798293, filed May 8, 2006, which is herein incorporated in its entirety by reference.

### FIELD

This specification relates to water filtration with immersed membranes.

### BACKGROUND

The comments in this background section are not an admission that anything discussed in this section is citable as prior art or part of the common general knowledge of persons skilled in the art in any country.

U.S. Pat. Nos. 6,303,035; 6,547,968; 6,375,848; 6,325,928; 6,893,568; and 6,555,005 describe various filtration processes using immersed membranes.

### SUMMARY

The following summary is intended to introduce the reader to this specification but not to define any invention. Inventions may reside in a combination or sub-combinations of the apparatus elements or process steps described below or in other parts of this document. The inventors do not waive or disclaim their rights to any invention or inventions disclosed in this specification merely by not describing such other invention or inventions in the claims.

An immersed membrane is a membrane, for example a membrane with pores in the microfiltration range or smaller, that is immersed, or adapted to be immersed, in water at generally ambient pressure such that an outer surface of the membrane is in communication with the water. Permeate is withdrawn from an immersed membrane by exposing a cavity defined by an inner surface of the membrane to a pressure less than the ambient pressure of the water, for example by connecting the suction side of a pump or a siphon to the cavity. An immersed membrane may be operated in a batch mode, meaning a process that alternates between generally dead end filtration and a deconcentration step. The deconcentration step may comprise steps of draining some or all, for example 20% or more or 50% or more, of the tank to remove reject water while permeation is stopped, then refilling the tank. Cleaning steps, such as backwashing or aerating the membranes may be performed before or during the deconcnetration.

In a batch process, the periods of dead end filtration may have a constant duration chosen to provide a desired quantity of water removed as permeate in a cycle relative to the quantity of water drained in a cycle. The periods of dead end filtration may be 10 to 30 minutes long and 80-90% of the feed water may be removed as permeate. Additional backwashes may be performed between deconcentrations to prevent or inhibit membrane fouling. However, fouling continues anyway and so, in a plant operated to provide a constant flow of permeate, the transmembrane pressure (TMP) must be increased as the number of cycles increases. Eventually, the TMP required to provide the design flow exceeds a maximum value set by mechanical limitations, for example, a limitation on the suction that a permeate pump can create or a limitation on the TMP that a membrane module can withstand before leaking or suffering a mechanical failure, typically modified by a factor of safety. Once the maximum TMP is reached, which may take a few weeks or more, an aggressive chemical cleaning called a recovery cleaning is performed. In the next cycle, TMP returns to a value generally like that of the first cycle with a new membrane module. Because recovery cleaning involves chemicals and disrupts the filtration process for an hour or more, operators try to slow the rise in TMP with each cycle to delay reaching maximum TMP.

The new processes described in this specification seeks to provide one or more of a long time between recovery cleanings, a useful ratio of permeating time to non-permeating time and a low ratio of water drained from the tank to water fed to the process. In the new processes, permeate is withdrawn through the membranes in a cycle for extended periods of time, for example an hour or more or 90 minutes or more, without backwashing. Without any invention being limited by this theory, the inventors believe that long filtration periods allows a layer of coarse foulants, that is foulants too large to fit into the pores of the membranes, to form on the outsides of the membranes. The membrane fouls rapidly as this layer is being formed since, at the same time, smaller particles enter the membrane pores. However, after a layer of larger foulants develops, this layer pre-filters the water and inhibits further fine foulants from reaching the membrane pores.

Increasing the duration of the dead end filtration cycle, for example to 60 minutes or more or 90 minutes or more, without backpulsing may achieve some benefits over a process with shorter cycle times. Further benefits may be achieved by optionally having an initially extended cycle time but allowing later cycles, in which the maximum TMP is reached before the end of a predetermined dead end filtration time, to continue as with dead end filtration periods less than the predetermined time. A recovery cleaning is not performed until maximum TMP is reached in a cycle within a second predetermined time, for example a time of 30 minutes or less or when the other backwash or deconcentration TMP at design flux or the permeability is above a limit value. Further optionally, the duration of all filtration cycles can be determined by the time taken to reach a maximum TMP, for example, 50 kPa or more or 75 kPa or more. Alternately, cycle times can be determined by the time taken until the earlier of (a) a specific increase in TMP, for example an increase of 15 kPa or more or 20 kPa or more, or (b) maximum TMP is reached. In the last two methods, recovery cleaning can again be triggered by the cycle time going below a predetermined limit. Alternately, recovery cleaning can be triggered by reaching a predetermined after deconcentration or backpulse TMP at design flux or permeability. The methods above may extend the time between recovery cleanings compared to a short cycle time process, or instantaneous flux may be increased to maintain the same recovery cleaning interval. In the methods above, a minimum permeability value may be used instead of the maximum TMP value. Alternately, the membranes can be run at a maximum TMP at all times and a deconcentration cleaning triggered by a flux or permeability set point. In this paragraph, maximum TMP may mean maximum TMP as described in previous paragraphs as a value determined by a mechanical limitation, or a design or control set point value which may be equal to, for example, between 70% and 100% of maximum TMP as defined by mechanical limitations.

Typical ranges of membrane permeability may be 2.5-12 gfd/psi; surface area per tank volume may be 5-50 ft²/gal; design flux may be 30-45 gal/ft²/day and maximum TMP as determined by mechanical constraints may be 12 psi.

### BRIEF DESCRIPTION OF THE DRAWINGS

One or more processes or apparatuses will be described below with reference to the following Figure(s).

FIGS. 1 and 2 are graphs of experimental results.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors and owners reserve all rights in any invention disclosed in an apparatus or process described below that is not claimed in this document and do not abandon, disclaim or dedicate to the public any such invention by its disclosure in this document.

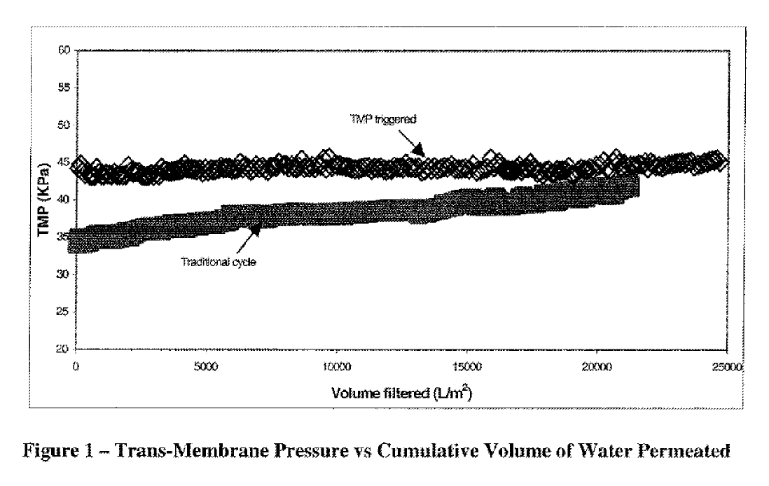

Experiments were run with immersed hollow fiber membranes, operated according to a batch process with a generally constant flux and within the parameters of paragraph 9. Long cycle times, for example up to 10 times or more longer than in traditional batch processes, were used and the TMP was allowed to reach a set TMP of 70-90% of maximum mechanically allowable TMP before backwashing was conducted. It was found when operated in parallel with an identical membrane and feed water using the traditional batch mode of operation that there is a performance advantage to running with long cycle times and a TMP triggered backwash instead of a time triggered backwash. The membrane TMP (measured after backwashing) increased more slowly in the TMP triggered backwash method (FIG. 1). In addition, due to the increased ratio of time permeating to time backwashing, there was an increase in net flow of water, or recovery rate, separately from the performance advantage. The combination of the increase in net flow and decrease in fouling rate makes this operating method very attractive. An additional advantage was a reduction in waste volume resulting from less frequent drain steps.

A potential concern with long filtration periods is that operating at high recoveries increases the solids levels towards the end of a dead end filtration cycle. Depending on the particular membrane module, solids tolerance boundaries may be breached. Accordingly, a solids tolerant module may be desirable. Further, an effective method of cleaning is also desirable. In particular, a cleaning and deconcentration procedure may involve aerating while slowly draining the tank or draining the tank in steps, for example to water levels corresponding to areas prone to sludging or to step through the entire depth of a module, and aerating for a period of time at each step. Some such desludging procedures are described in U.S. Publication No. 2006-0065596 A1 which is incorporated herein, in its entirety, by this reference to it. Alternately, maximum concentration may be reduced by a full or partial drain or flush (that is opening a drain but also increasing feed below to keep the membranes immersed) between backwashes or by adding a retentate bleed during the entire, or a later part, of the filtration period.

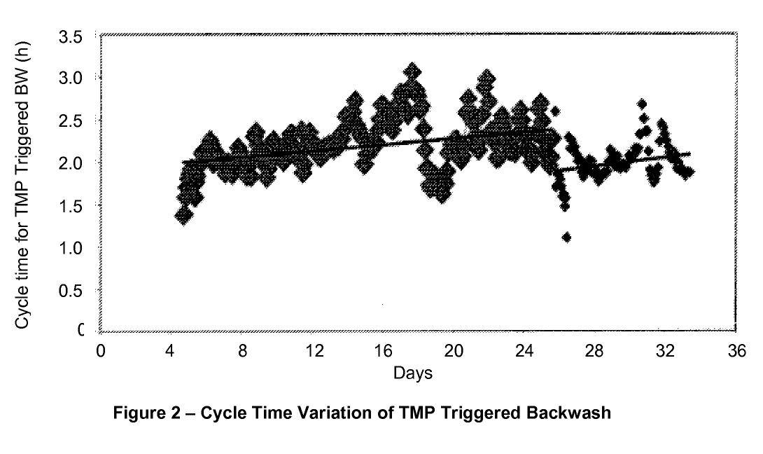

The results of the experiments discussed above are provided in the following Tables 1 and 2 and FIGS. 1 and 2.

TABLE 1
Process Operating Details of Side-by-Side Membranes Operated at
Same Instantaneous Flux (30 gfd)

| Traditional Batch Process for | | | | | |
|---|---|---|---|---|---|
| Immersed Membranes | | | TMP Triggered Backwash Process | | |
| | | Duration | | | Duration |
| Step | Process | (minutes) | Step | Process | (minutes) |
| 1 | Start Permeation | 30 | 1 | Start Permeation | 120–300 |
| | | | | | (continues |
| | | | | | until |
| | | | | | TMP = TMPₘₐₓ |
| 2 | Stop Permeation, | 0.5 | 2 | Stop Permeation, | 0.5 |
| | Start Aeration, Start | | | Start Aeration, | |
| | Backpulsing | | | Start Backpulsing | |
| 3 | Stop Backpulse, | 1.5 | 3 | Stop Backpulse, | 1.5 |
| | Continue Aeration, | | | Continue | |
| | Drain Tank | | | Aeration, Drain | |
| | | | | Tank | |
| 4 | Stop Aeration, Fill | 1.5 | 4 | Stop Aeration, Fill | 1.5 |
| | Tank | | | Tank | |

TABLE 2
Process Performance Analysis

| Traditional Batch Process for | |
|---|---|
| Immersed Membranes | TMP Triggered Backwash Process |
| Net Flux = 27 gfd | Net Flux = 29.7 gfd |
| % of Feed Water Recovered = 87.5% | % of Feed Water |
| | Recovered = 97.2% |
| % of Feed Water Wasted = 12.5% | % of Feed Water Wasted = 2.8% |
| Fouling Rate = 0.4 kPa/d | Fouling Rate = 0.1 kPa/day (over 3 |
| (over 3 weeks) | weeks) |

The invention or inventions which are currently claimed in this document are described in the following claims.

We Claim:

1. An immersed membrane filtration process in which the length of one or more filtration periods between subsequent backwashes is chosen or controlled such that, immediately prior to a backwash, the system is operating at a combination of TMP and flux values near the mechanical limits of the system.

2. The process of claim 1 wherein flux is generally constant.

3. The process of claim 1 wherein TMP immediately prior to a backwash is 8 psi or more.

4. The process of claim 1 wherein the time between at least some pairs of subsequent backwashes is 60 minutes or more or 90 minutes or more.

5. The process of claim wherein 1 time between at least some pairs of subsequent backwashes is determined by reaching a predetermined value in the range of 70 to 100% of a design maximum TMP while operating at a generally constant design flux.

6. The process of claim 1 further comprising a deconcentration step after or during the backwashings.

7. The process of claim 1 comprising air scouring the membranes while draining a tank, or while the surface of the water in the tank is at a plurality of heights passing through the membranes.
